(19) United States
(12) Patent Application Publication
(10) Pub. No.: US 2026/0295407 A1
(43) Pub. Date: Oct. 1, 2026

(54) SYSTEMS AND METHODS OF ADDRESSING COMPRESSION ARTIFACTS IN VIDEO STREAMS

(71) Applicant: NINTENDO CO., LTD., Kyoto (JP)

(72) Inventors: Pierre CORDANI, Nogent sur Marne (FR); Christophe AGUETTAZ, Ivry sur Seine (FR); Damien RAFFARD, Joinville-le-pont (FR); Sebastien GUIDO, Saint Ouen (FR)

(21) Appl. No.: 19/226,711

(22) Filed: Jun. 3, 2025

Related U.S. Application Data
(60) Provisional application No. 63/781,708, filed on Apr. 1, 2025.

(51) Int. Cl. A63F 13/52; G06T 3/40; G06T 5/20; G06T 5/60; G06T 5/70; G06T 5/92; H04N 19/86

(52) U.S. Cl. CPC A63F 13/52; G06T 3/40; G06T 5/20; G06T 5/60; G06T 5/70; G06T 5/92; H04N 19/86; G06T 2207/10016; G06T 2207/20081; G06T 2207/20084

(57) ABSTRACT

The technology described herein relates to video streams and image or video compression. More particularly, the technology described herein relates to addressing or removing (e.g., in real-time) image or video compression artifacts that are included in a data stream.

### CROSS REFERENCE(S) TO RELATED APPLICATION(S)

This application claims priority to U.S. Provisional Application No. 63/781,708, filed Apr. 1, 2025, the entire contents of which are hereby incorporated by reference.

### TECHNICAL OVERVIEW

The technology described herein relates to video streams and image or video compression. More particularly, the technology described herein relates to addressing or removing (e.g., in real-time) image or video compression artifacts that are included in a data stream.

### INTRODUCTION

Video technology is an important aspect for video games. It is used in connection with images generated by game engines as players interact with a virtual environment. It is used for pre-rendered cinematics that enhance storytelling elements within games (e.g., movies). More recently, video technology is also used to facilitate the transmission of gameplay streams between users, allowing one player to capture and share their gaming experience with others. This streaming capability creates opportunities for shared experiences by enabling players to observe or participate in another player's gaming experience.

While video is an important part of video games, the storage or transmission demands for handling such video can be challenging-especially with video games offering increasing image/video resolutions. For example, an uncompressed 4 k video stream (30 frames per second) can require multiple gigabits per second of bandwidth. Such requirements can tax even local access (a local hard drive)—much less video streams that are provided over a network, such as a wireless network.

To alleviate some of these technical requirements, video compression is used. Video compression allows for decreasing the amount of data required to represent videos at an acceptable visual quality. This enables more efficient storage and transmission—such as over wireless channels. Modern compression techniques include H264, H265 (HEVC), AV1, and others.

A downside to compression is that it introduces compression artifacts. Such artifacts include macroblocking, mosquito noise, chromatic aberrations, ringing effects, and others. How much these and other types of artifacts affect displayed video can vary from situation to situation. However, in some instances the artifacts can severely affect the video quality-especially in cases where a video stream is highly compressed. For example, when a video stream has been communicated via a wireless connection.

Accordingly, it will be appreciated that new and improved techniques, systems, and processes are continually sought after.

### SUMMARY

In certain example embodiments, inference is performed with a trained model that allows for displaying or processing video in real-time while operating in environments with constrained network, processing, and/or energy resources. The trained model provides an output that results in a cleaner frame (e.g., by removing or counteracting) artifacts from a video stream while also allowing inference to be performed in under (as an illustrative example) 10 ms per video frame. In certain example embodiments, the video is a real-time video stream that is provided from a game device.

In certain example embodiments, a model (e.g., a single model) is trained and then provided. The model may be capable of dynamically (e.g., intelligently) determining when and how aggressively to clean a given frame of a video. This approach helps to provide a level of intervention that is related to the quality of the image being “cleaned.” A smaller amount of change (e.g., intervention) is provided on good-quality images, while larger changes and robust cleaning on heavily degraded ones.

In certain example embodiments, the luminance channel (Y-channel) of an image that is in the YUV color space (which may have been converted from RGB) is used during inference for the trained model. In certain example embodiments, the UV channels are upscaled using bilinear interpolation that is based on the Y-channel's high-quality upscaled output. The reconstructed YUV output may then be converted back to RGB for display and/or further processing. This type of approach can assist in improving (e.g., maximizing) a sharpness and/or visual quality of the resulting image.

In certain example embodiments, a model includes a filter that can be applied on a color image. Such a filter may be applied for upscaling or other image improvements (sharpening, noise reduction, etc.). In certain example embodiments, the same or similar filter may be applied on a single channel image that is computed from a combination of the source channels (for instance, Y as the brightness). The model uses the correlation of the channel in the source image to this composed channel in a neighborhood close to the processing pixel location in order to predict a new value for an upscaled image of this channel given the upscaled value of the composed channel at the output pixel location. The filters used in certain example embodiments may be optimized towards time and power consumption requirements. Such techniques can be used for any or all of the following applications. First, the techniques may be used for block reduction in video images using a deep learned neural network for the Y channel of a video, with the U and V being upscaled. Second, the techniques may be used for upscaling of an image using deep learning upscaling of the single channel Y buffer of an image and then upscaling the U V channels using the techniques described herein (e.g., via bilinear interpolation or the like). Third, upscaled rendering over multiple frames using an accumulation in a single channel Y buffer and then regenerating the U and V from pixels of the local neighborhood in the last rendered frame.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages will be better and more completely understood by referring to the following detailed description of example non-limiting illustrative embodiments in conjunction with the drawings of which:

FIG. 1 is a block diagram that includes an example computer system according to certain example embodiments;

FIG. 2 is a flow chart of the training process that is performed to train a model according to certain example embodiments;

FIG. 3 is a flow chart of preprocessing operations performed for training of a model according to certain example embodiments;

FIGS. 4A-4B are architecture diagrams illustrating examples of how a model may be trained according to certain example embodiments;

FIG. 5 is a block diagram that includes an example training computer system according to certain example embodiments;

FIG. 6 is a flow chart of processing performed at run time for processing compressed media according to certain example embodiments;

FIG. 7AA is a flow chart of a runtime process that may be performed during execution of a video game according to certain example embodiments;

FIGS. 7A and 7B are screen shots, in color, that illustrate before and after images; FIGS. 8A and 8B show zoom in portions, in color, of a portion of the images from FIGS. 7A and 7B; FIGS. 9A and 9B are grayscale versions of FIGS. 8A and 8B; FIGS. 10A and 10B are grided versions, in color, of FIGS. 8A and 8B to illustrate the before and after of the banding processing that may be performed according to certain example embodiments; and

FIG. 11 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

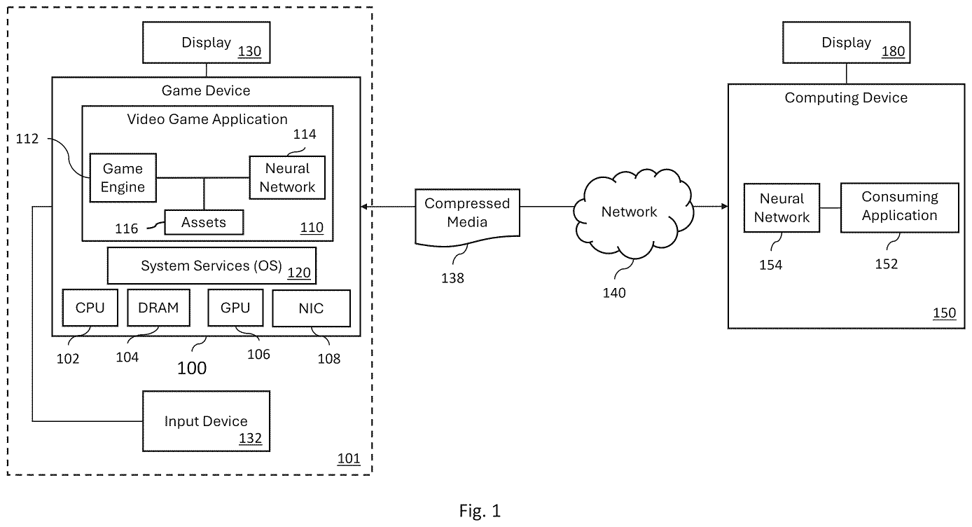

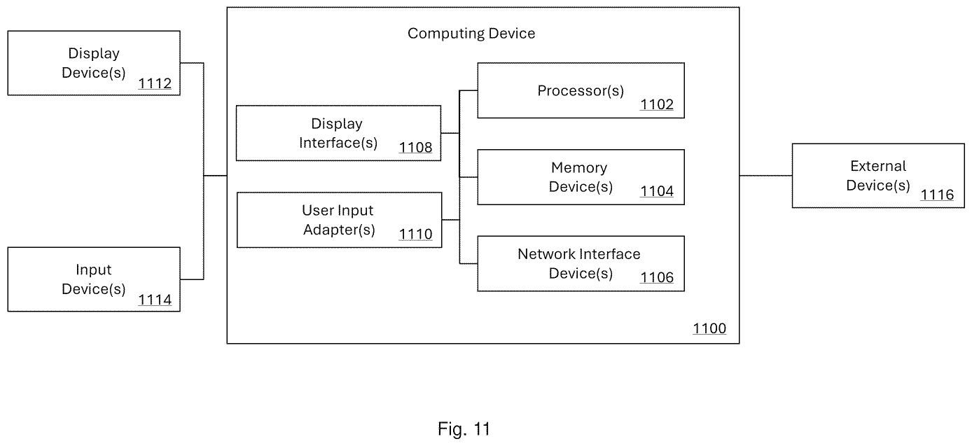

In many places in this document, including but not limited to the description of FIG. 1, software modules, software components, software engines, and/or actions performed by such elements are described. This is done for ease of description; and it should be understood that, whenever it is described in this document that a software module or the like performs any action, the action is in actuality performed by underlying hardware elements (such as a processor, hardware circuit, and/or a memory device) according to the instructions that comprise the software module or the like. Further details regarding this are provided below in, among other places, the description of FIG. 11.

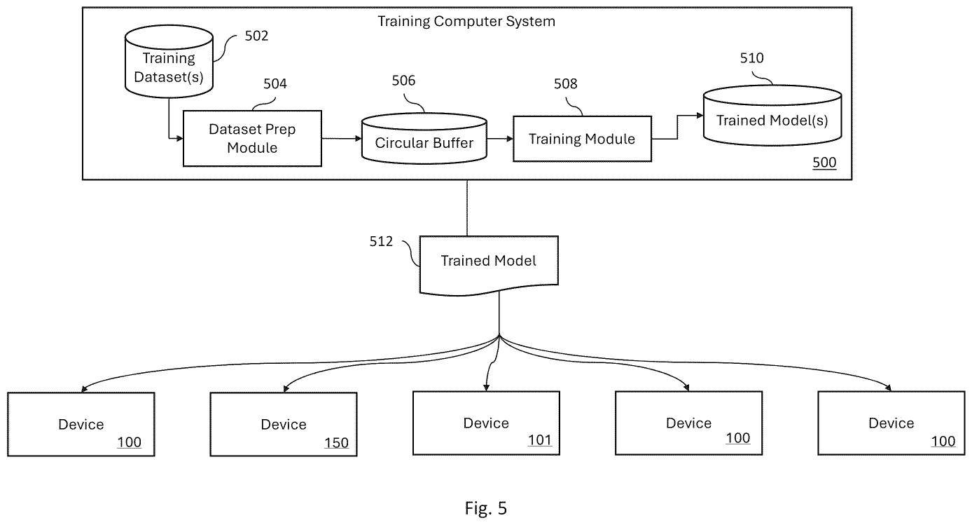

Some reference numbers are reused across multiple Figures to refer to the same element. For example, game device 100 first shown in FIG. 1 is also referenced and described in connection FIG. 5.

### Overview

Certain examples herein relate to training models (e.g., a neural network) and performing real-time inference using those trained models. In certain examples, the model that is trained is, for example, optimized for real-time GPU execution in a resource constrained environment-such as a mobile device. The model that is trained may be based on a UNet architecture and trained to handle video compression artifacts.

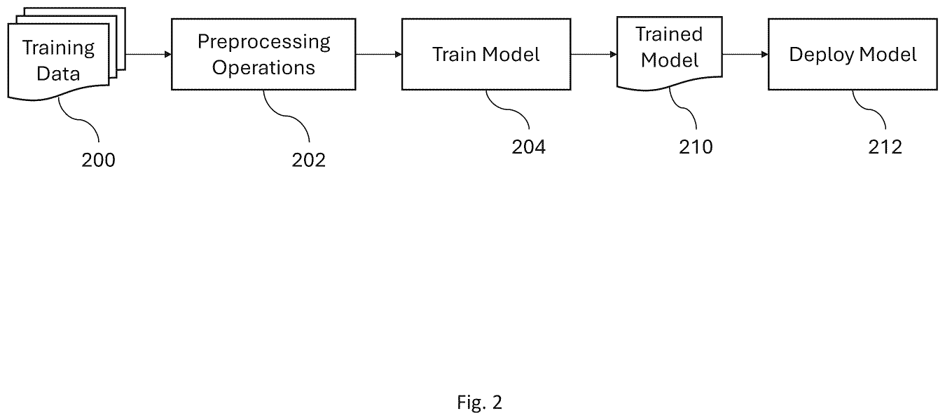

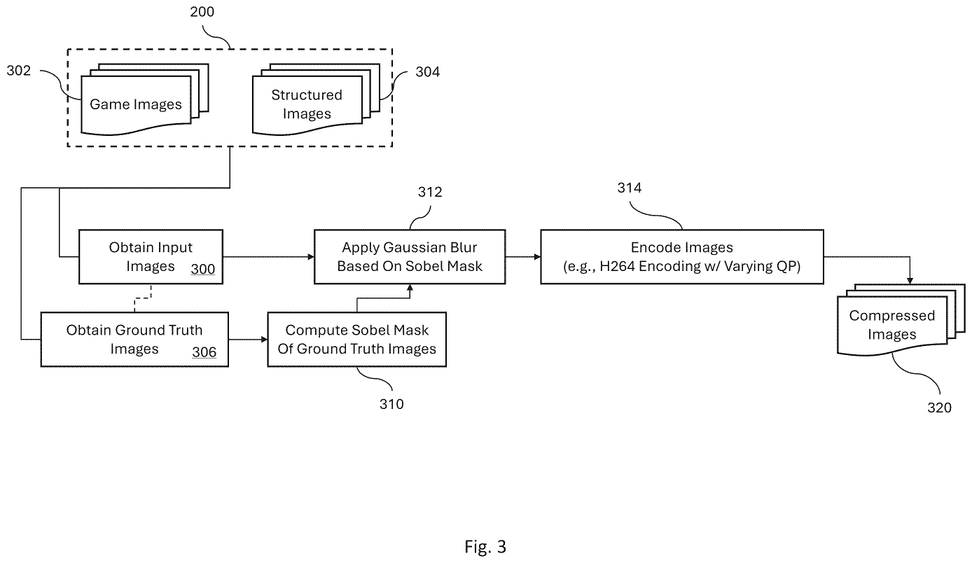

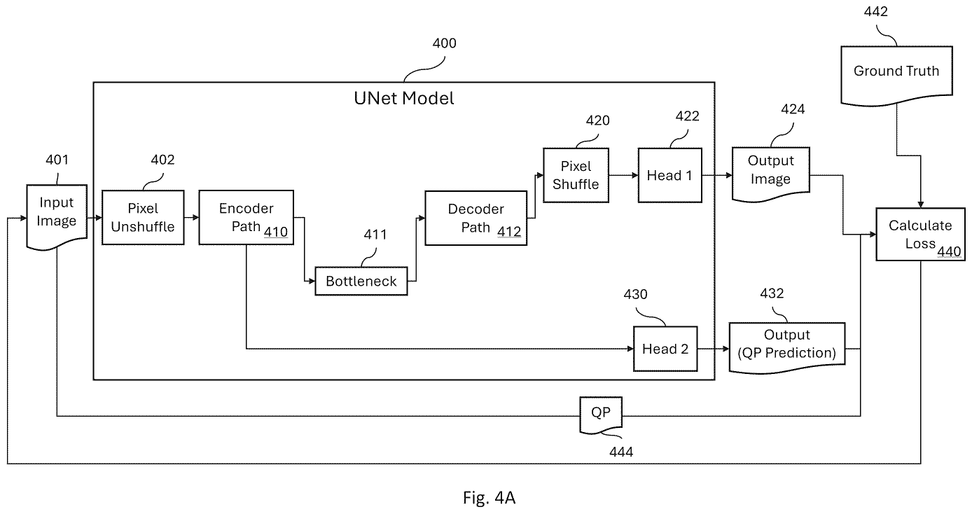

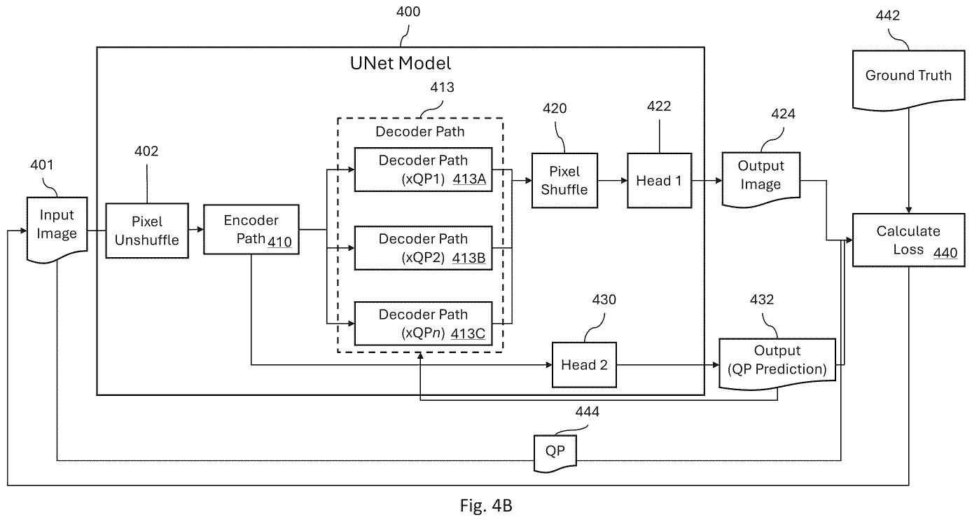

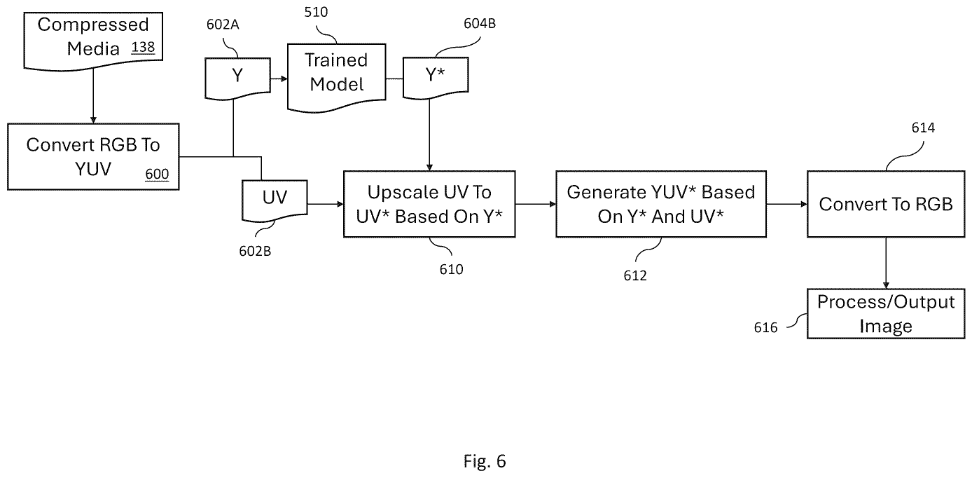

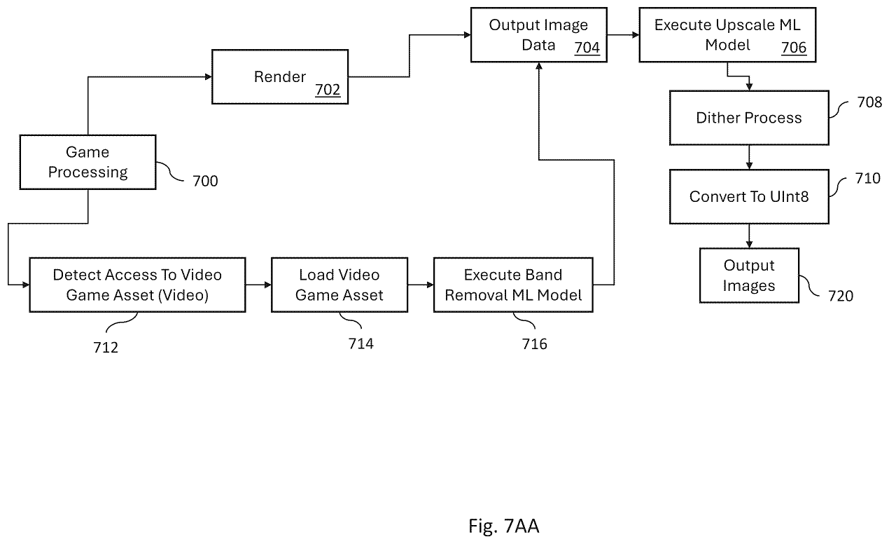

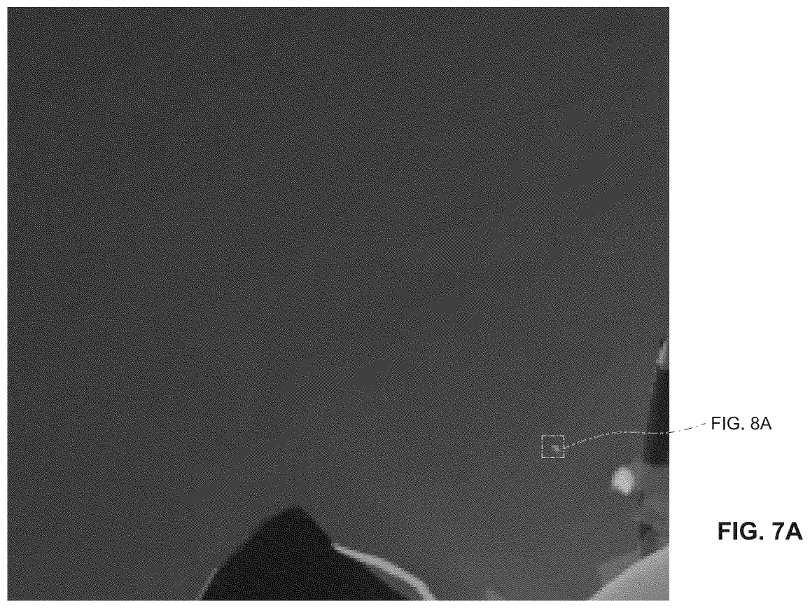

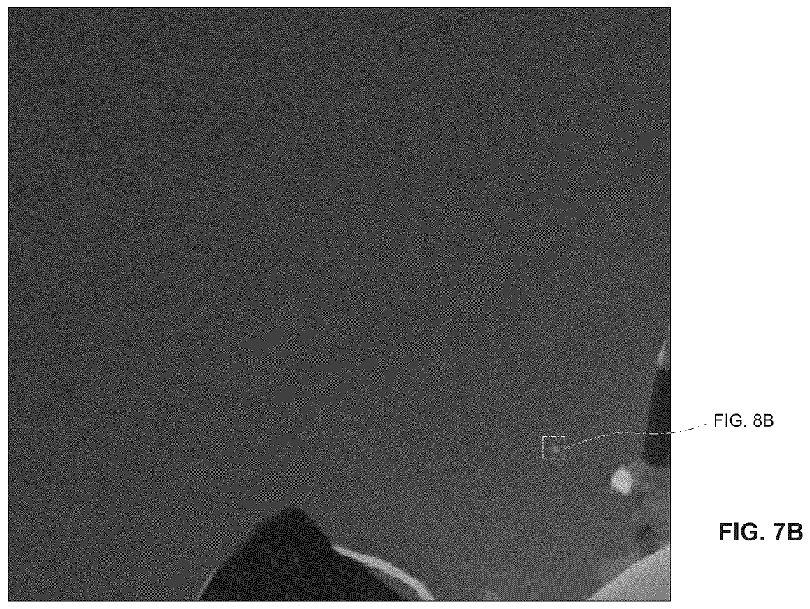

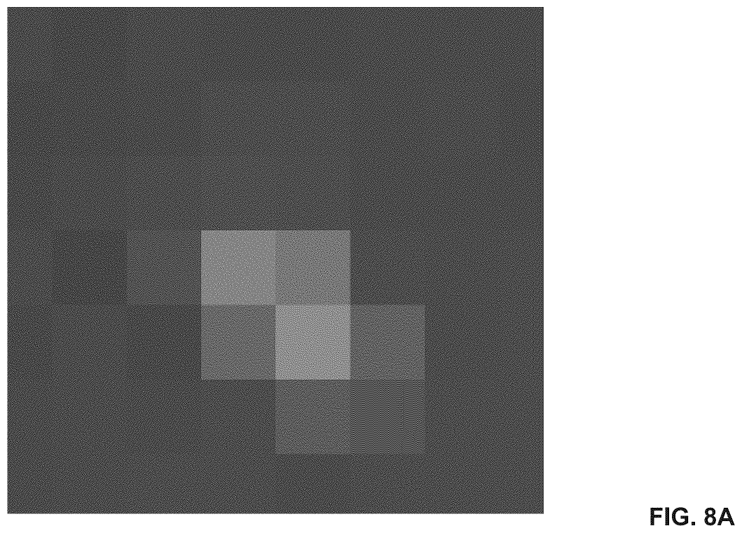

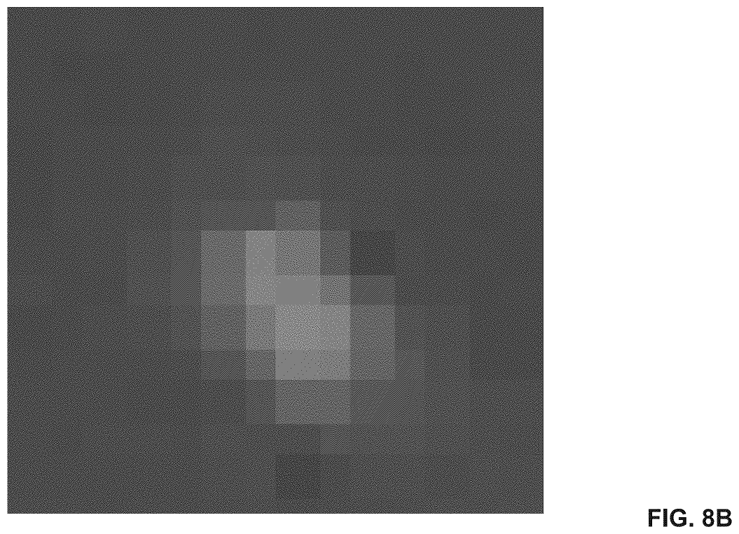

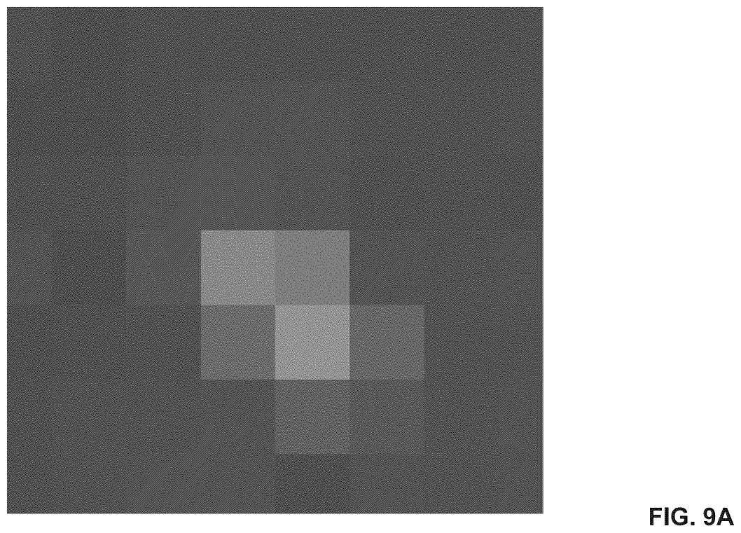

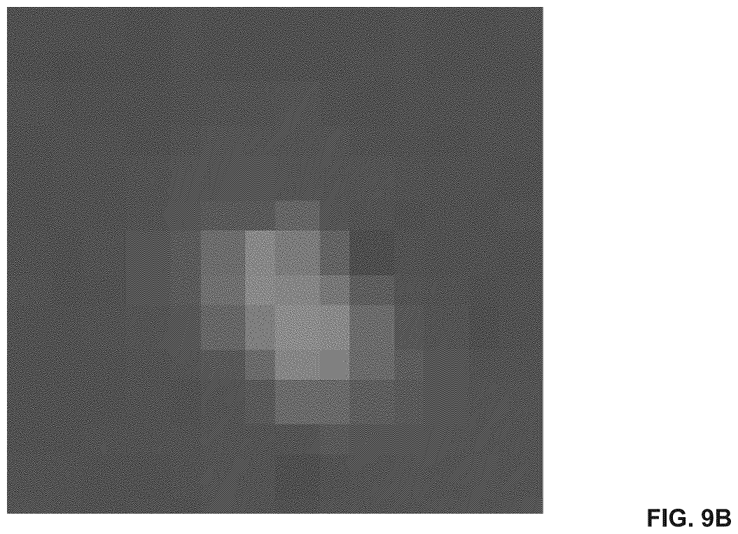

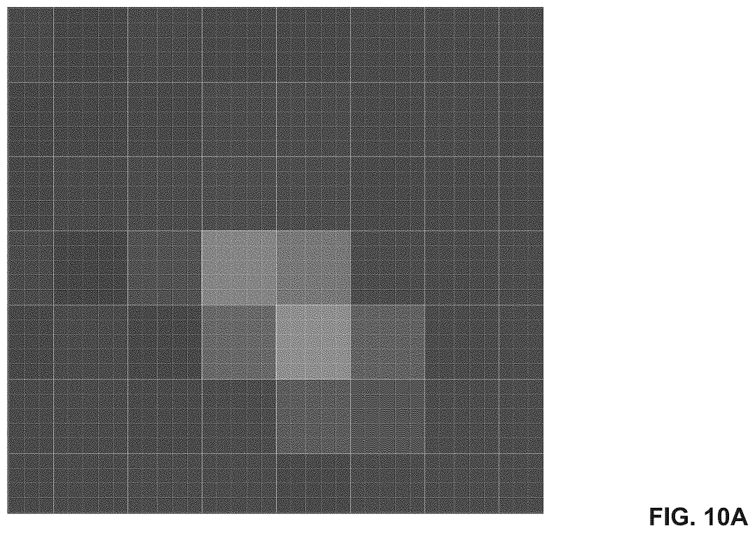

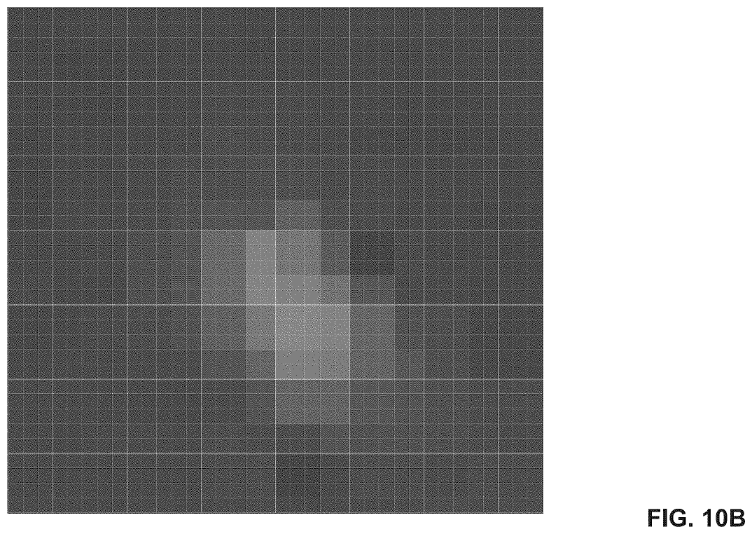

FIG. 1 is a system diagram of two computing devices that may use neural networks in connection with displaying output to users on a display. FIG. 2 is a flowchart of an overview of a training process. FIG. 3 is a flow chart of preprocessing operations that may be performed for the training process of FIG. 2. FIG. 4 is an architecture diagram that illustrates aspects of how a model is trained as part of the process shown in FIG. 4. FIG. 5 is an example of a training system used to train models using the process shown in FIG. 2. FIG. 6 is a flow chart that illustrates processing performed during inference using a trained model. FIGS. 7A-10B illustrates aspects related to banding and how example models may be used to address or remove such banding via a trained model.

### Description Of FIG. 1: Game Systems

FIG. 1 is a block diagram that includes an example computer system according to certain example embodiments. In certain examples, the computer system is a game device 100, such as a mobile game device.

Game device 100 is an example of the computer system 1100 shown in FIG. 11. While the term “game” device is used in connection with certain example embodiments herein, this is done for ease of use, and any type of computing device may be used. Indeed, a “game” device as used herein may be a computing device (e.g., a mobile phone, tablet, home computer, etc.) that is being used (or will be used) to play a video game at that time. A non-limiting illustrative list of computing devices may include, for example, a smart or mobile device (e.g., a smart phone), a tablet computer, a laptop computer, a desktop computer, a home console system, a video game console system, a home media system, cloud-based computing system with a thin client (e.g., a smart TV, a mobile device, or the like), and other computer device types. As explained in connection with FIG. 11, computers can come in different sizes, shapes, functionality and the like.

In certain example embodiments, the techniques discussed herein can be used in conjunction with non-game applications. For example, they may be used in conjunction with real-time video surveillance, video stream, movies, or other applications that use video that may be compressed.

Game device 100 may include CPU 102, GPU 106, DRAM (dynamic random-access memory) 104, and network interface (NIC) 108. CPU 102 and GPU 106 are examples of processor 1102 from FIG. 11. DRAM 104 is an example of memory devices 1104 from FIG. 11. Different types of CPUs, GPUS, DSPs, dedicated hardware accelerators (e.g., ASICs), FPGAs and memory technology (both volatile and non-volatile) may be employed on game device 100.

Examples of different types of CPUs include x86 CPU architecture and ARM (Advanced RISC Machine) architecture. Examples of different GPUs include discrete GPUs and integrated GPUs that may be found on a system-on-a-chip (SoC). SoCs may combine two or more of the CPU 102, GPU 106 and local memory like registers, shared memory or cache memory (also called static RAM or SRAM) onto a single chip. DRAM 104 (also called dynamic RAM) is usually produced as a separate piece of semiconductor and connected to the SoC through wires. In certain examples, the processing capabilities provided by the CPU, memory components, GPU, and/or other hardware components that make up a given game device may be different on other game devices. Some game devices may be mobile (e.g., a smart phone or tablet), some may be stationary game consoles, or operate as personal computers (e.g., a desktop or laptop computer system that is used to play video games).

Game device 100 includes a network interface (NIC-a network interface card) that is an example of a Network Interface Device 1106 that is discussed in connection with FIG. 11. The NIC may support wireless and/or wireless communication functionality to thereby enable communication with another computing device (150).

Game device 100 may also be coupled to input device 132 and display device 130. In certain examples, input device 132 and/or display device 130 may be integrated into one or more housings as game device 101. Unless otherwise noted, the features of game device 100 may be used in connection with game device 101.

Examples of input device 132 include video game controllers, keyboards, mice, touch panels, sensors, and other components that may provide input that is used by the game device 100 to execute application programs and/or video games that are provided thereon. The input device(s) may be integrated with the game device or separate.

Examples of display device 130 include a television, a monitor, an integrated display device that is part of game device 101, and the like. In certain examples, game device 100 may be configured to output images to different types of display devices. For example, a game device include an integrated display (e.g., that is part of the structural body that houses game device) on which images may be output. A game device may also be configured to output images to a larger television or other display device. In certain example embodiments, the different display devices may natively display different resolutions. For example, the integrated display of a game device may have a first resolution (e.g., a 1080p display) and a separate display may have a second resolution (e.g., a 4 k display).

In certain example embodiments, the game device may select which neural network (or a version of a neural network) to use based on the target output resolution. For example, a first neural network may be used when outputting to a 1080p display and then a second neural network may be used when the same game device is outputting to a 4 k display. Thus, different models may be used to provide different outputs depending on application need. In some examples, the game device may determine or detect the output resolution of the display and then automatically select the appropriate neural network 114 to generate images of that resolution.

Game device 100 stores and executes one or more video game application(s) 110. Included in the video game application program may be game engine 112, assets 116, and neural network 114 (which may also be provided via system services 120—discussed below). The game device 100 may also store image data (e.g., textures) and other types of assets (e.g., sound, text, pre-rendered videos, etc.) that are used by the video game application 110 and/or game engine 112 to produce or generate content for the video game (or other application) such as, for example, images and/or videos for the game. Such assets may be included with a video game application program on a CD, DVD, or other physical media, or may be downloaded via a network (e.g., the Internet) as part of, for example, a download package for the video game application 110.

The game engine 112 includes program code for generating images that are to be output—e.g., to display 130. Also, as discussed herein, such images may be communicated to another computing device (150) for display thereon. Game engine 112 may include program structure for managing and updating the position of an object(s) in a virtual space based on inputs provided from the input device 132. The data for the virtual space may then be used to render an image of the virtual space by using, for example, a virtual camera. Game engine 112 may render images at a rate of 30 frames per second, or 60 frames per second. In certain examples, variable render rates may be used (e.g., depending on scene complexity or the like).

The generated image may be a source image. The source image may be generated at a first resolution (e.g., 540p, 1080p, etc.). In some examples, the source image may be compressed and communicated as compressed media 138, via network 140, to another computing device 150. The compressed media 138 may be individual images and/or may be a video stream. The compressed media 138 may be images from a video game (e.g., rendered by a first game device and being communicated to a second game device) or may be other types of image data—such as from a video camera or the like.

In some examples, the source image can be applied to a neural network 114 that converts the source image into an upconverted image (e.g., an upconverted image is generated based on application of the source image to the neural network 114) that is at a higher resolution than the original source image. That upconverted image is then output to the display device 116 for display thereon. Additional description for how images may be converted (e.g., upscaled) may be found in U.S. Pat. No. 11,494,875, the entire contents of which are hereby incorporated by reference.

It will be appreciated that while a video game application 110 is used for the purposes of description, other applications that provide image or video output could be used in connection with various example embodiments.

Game device 100 also includes system services 120. System services may be an operating system (OS) that is provided by the game device 100. System services 120 may include one or more additional services that may be accessed by any game application being executed on game device 100. As an illustrative example, system services 120 may include a process for executing a neural network or model using the techniques described herein. Indeed, in some examples, the neural network 114 may be provided as part of system services 120 instead of within the game application110. For example, and as discussed in greater detail elsewhere herein, system services 120 may provide processing for game applications to handle compression artifacts (e.g., via a trained neural network) in video, images, or other data.

System services 120 may also provide for compressing images and/or video that are communicated, as compressed media 138, to other devices (including device 150) via network 140. For example, system services 120 may include a H264 compression process that provides a data stream that results in compressed media 138.

In certain examples, the generation of compressed media 138 may be based on the overall quality of the network (or connection) between a source (game device 100) and destination (computing device 150). As an illustrative example, H264 can include a quality parameter that indicates how aggressively the source media should be compressed. A higher compression factor may be used for when the connection between game device 100 and computing device 150 is poor. Different compression factors may be used depending on determination of the quality of the connection. Varying the compression factor may allow the rendering of images based on compressed media 138 to performed at or near a constant frame rate (e.g., 30 fps) on the computing device 150. A downside to higher compression factors is that additional compression artifacts may be introduced into the compressed media. Certain example techniques discussed herein seek to address such compression artifacts.

Game device 100 communicates compressed media 138 to computing device 150. Computing device may be the same or similar to game device 100 or may be a different type of computing device (e.g., a smart TV, a desktop personal computer, a mobile phone, etc.). The compressed media 138 is received by the computing device 150 and then displayed on display device 180 via a consuming application 152.

The consuming application 152 may be another instance of the video game application 110 or may be different application that is for watching the video stream provided by the game device 100. In certain examples, as part of displaying a video and/or images, the compressed media 138 is passed through a neural network (e.g., a machine learned model) 154 that is provided on computing device 150. The neural network may have been trained to handle (e.g., address, fix, decrease the visual prevalence of, etc.) compression artifacts introduced when compressed media was generated by the game device 100.

Neural network 154 may operate to upscale compressed media 138 from a first resolution (e.g., 540p) to a second resolution—while also addressing compression artifacts in the compressed media 138. In certain example embodiments (and as discussed in connection with FIG. 4), the neural network may perform processing to reduce artifacts that have resulted from the compressed media 138 without additionally upscaling the output.

The neural network 154 may be a lightweight UNet-based neural network (also called a model, a ML model, or the like). In some examples, neural network 154 may be optimized for real-time GPU execution. An example UNet architecture for the neural network 154 may be relatively shallow and use a relatively small number of convolutional filters (e.g., as compared to other types of UNet models for similar types of tasks). However, this type of architecture can make training the network more challenging than other types of neural networks. Examples of how to train such a neural network are provided in connection with the descriptions of FIGS. 2-4.

In certain example embodiments, and as discussed in greater detail in FIG. 6, the neural network 154 operates based on the YUV color space of the received compressed media. Accordingly, when the compressed media 138 is received by computing device 150, it may be converted from RGB to YUV. The neural network 154 may then process the Y channel data, with the UV chrominance channels upscaled (if upscaling is desired) using bilinear interpolation based on the Y channel output from the neural network.

### Description Of FIG. 2: Training Process Overview

As discussed herein, processing resources for certain types of computing devices (e.g., game device 100/101 or the like) may be constrained. This may be due to power limitations while running on battery or constrained graphics processing power. With such constraints, an example UNet architecture may be relatively shallow and use a relatively small number of convolutional filters. An illustrative example of how shallow a UNet model (e.g., model 154) may be in connection with certain examples is that the model may have 14 convolution layers (e.g., less than 20, less than 16, etc.), across 3 levels, with the deepest level of the model having 64 channels. The UNet model may have less than 200 k (or less than one million) parameters in some instances. It will be appreciated that this type of architecture is noticeably different than other image related machine learning architectures that may have millions, or even billions of parameters. It will also be appreciated that this type of architecture can make training more challenging in certain examples.

In certain example embodiments, and as discussed in FIG. 4, the UNet architecture also leverages pixel shuffle and unshuffle operations to reduce spatial dimensionality and accelerate processing.

In certain example embodiments, a UNet neural network is adapted to handle upscaling to multiple different resolutions. For example, by ×1, ×1.33, ×1.5, ×2, ×3, or other selected scaling factor. The upscaling capability is integrated directly into the network architecture by adjusting the number of filters that are included in the decoder operations of the UNet. As an illustrative example, double the number of filters may be applied to a decoder involved in upscaling an image to ×2 versus one that is scaled by ×1. This adjustment of filters may be provided by a UNet architecture—e.g., by appropriately adjust the number of filters to handle scaling of ×1, ×1.33, ×1.5, ×2, ×3, or the like. More specifically, different versions of the same architecture may be trained to handle different upscaling requirements. Accordingly, for example, different versions of model 500 (for example) may be trained for ×1, ×1.33, ×1.5, ×2, ×3 and each of the resulting models may be stored on game device 100 for use in connection with upscaling to a desired resolution (or not upscaling at all).

In certain example embodiments, the adjustment of the number of channels (also called filters herein) is performed before a final pixel shuffle. The final pixel shuffle (e.g., with r=2 or the like) is performed to convert the remaining channel dimensions into spatial dimensions at the target resolution—this allows the neural network to maintain a relatively small spatial dimension throughout (e.g., most) of the processing steps and perform efficient upscaling in the final reconstruction layer of the neural network.

In certain example embodiments, RGB image data may be used for training. An example of training on RGB data may be provided in connection with the banding removal techniques discussed in FIGS. 7A-10B. Alternatively, in certain example embodiments, the neural network may be trained based on the YUV color space of images instead of traditional RGB. In certain example embodiments, the RGB data may be converted to YUV and the YUV image data then used to train the model. In certain examples, the model may be exclusively trained on the Y channel the YUV color space and the UV channels extracted (in the case of upscaling) using bilinear interpolation.

Note that in some examples (and as discussed in connection with FIG. 6), only the Y channel of a YUV color space may be used at inference for a trained model. With such an implementation, should upscaling be desired, the UV chrominance channels are upscaled based on the output of the Y-channel (e.g., which may be higher quality and/or upscaled). In some examples this upscaling of the UV chrominance channels is performed using bilinear interpolation based on the Y-channel output.

Turning now more specifically to FIG. 2, a flow chart of an example training process is shown. This training process may be implemented on the training computer system 500 that is shown in FIG. 5.

At 202, training data 200 is subject to one or more preprocessing operations. Training data 200 includes both input images and ground truth images. As discussed in connection with FIG. 3, different types of images may be provided within training data 200. Additional details of example preprocessing operations are shown in FIG. 3.

At 204, the model (e.g., a UNet model) is trained to generate a trained model 210. Additional details of the training architecture is shown in FIG. 4.

At 212, trained models may be deployed to one or more computing devices (e.g., game device 100, game device 101, computing device 150, etc.) for use by users (where inference may be performed-discussed in connection with FIG. 6).

### Description Of FIG. 3: Preprocessing

FIG. 3 is a flow chart of preprocessing operations performed for training of a model according to certain example embodiments. The preprocessing operations can be performed in a distributed manner and/or asynchronously with the training of a model.

Training data 200 includes a hybrid dataset of images that include game images 302 that are generated via a game engine (e.g., game engine 112) and structured images 304.

Game images 302 may include those generated with varied textures, complexities, and the like. Multiple different types of games may be used to generate a set of game images. This approach can help to provide the model with a representative selection of practical video scenarios (e.g., those that the model may be used for). Game images 302 include both input game images and ground truth game images. Ground truth game images may be generated using high quality textures and/or target rendering resolution. Alternatively, or additionally, a trained model may be used to generate high quality images that have (in cases where increased resolution is desired) been upscaled. The model used for this may be larger (substantially so) and require more processing power and/or time in order to upscale an image.

Structured images 304 may be those that are synthetic and/or geometric. Such images may be simple, but highly structured. Structured images 304 may be used to provide training data with strong edge representations (e.g., to help the model generalize well across different types of game or video content). In some examples, further types of images may be included in the training data 200 (e.g., depending on application need). In some examples, such images may be generated by using the Cairo library. The Cairo library may be used to generate input images and ground truth images. For example, the same image may be generated at 1080p and 4 k (or other desired resolution for the ground truth image).

The training data 200 may be stored in storage and allow the training data to be access for training new models.

At 300, input images are obtained using the training data. Correspondingly, at 306, the ground truth images for those input images may be generated and/or obtained.

In certain example embodiments, the preprocessing pipeline may include edge-aware degradation of the input images. For this, at 310, a Sobel mask is computed from the ground truth images is generated. Then, at 312, a gaussian blur is applied to the input images based on the Sobel mask computed directly from the high-quality ground truth frames. In other words, the Gaussian blur is guided by the Sobel mask (e.g., the blurring occurs where the mask is present). The resulting selective blurring of the input images allows the model to be trained to restore sharp edges and high-contrast areas—while also guarding against introducing ringing effects into the image. Such aspects can be the most visually significant regions in video frames and thus addressing compression artifacts in those can assist with correcting from compression introduced artifacts. This type of approach may also help when the resulting trained model is relatively small.

Next, at 314, the now modified input images are then encoded using a compression algorithm. In certain examples this may be H264 or the like (e.g., AV1, H265, etc.). In certain examples, the Quantization Parameter (QP) (in the case of H264) may be varied randomly, such as between an upper and lower bound (e.g., between 18 and 52 or the like). With a QP of 18 representing a high-quality frame with minimal artifacts and a QP of 52 representing a low quality with significant artifacts. This approach of varying the QP can simulate a wide range of real-world video compression scenarios. In certain examples, a single given input image (which is associated with a corresponding ground truth image) may have many different associated compressed versions thereof. In other words, the QP applied to a given image over the course of training may be varied (e.g., randomly or via other techniques) to thus allow the same input image to be compressed differently. This allows the model to learn how images of varied QP values (e.g., form the same image) should be handled towards the same target ground truth image. In other words, a single ground truth image (e.g., from 306), will be associated with multiple different encoded images from the same input image, which have different QP values. The varying of the QP may be repeated across the thousands or millions of different input images (and corresponding ground truth images) that may be used as part of the training process.

The resulting compressed images 320 are then used in training (discussed in FIG. 4 below).

In certain examples, the preprocessing may also include selectively cropping portions of the training images.

### Description Of FIGS. 4A-4B: Training Architecture

FIG. 4A-4B are architecture diagrams illustrating examples of how model(s) may be trained according to certain example embodiments. FIG. 4B is an architecture diagram that leverages a predicted QP value to select one of a plurality of decoder paths. Additional details related to FIG. 4B are discussed in connection the adaptive artifact removal embodiment discussed herein.

In some examples, different models may be trained for handling different types of scaling factors. A first instance of a model may be trained for ×1 scaling, a second instanced for ×1.5, and third instance at ×2, and a fourth at ×3. Each instance may be trained as based on the model shown in FIG. 4A.

Note that in certain example embodiments the trained model may be expected to operate by processing at least 30 frames per second. In certain examples, the speed at which inference may be performed by a resulting trained model may be less than 10 ms (per frame). Such processing demands may require in certain examples that the resulting trained model may be smaller than other types of models that handle similar tasks. However, the model may be expected to perform at (or nearly on) the level of larger and/or slower models.

Turning to the training architecture, compressed images that are generated via the processing operations discussed in FIG. 3 are used to train a UNet model 400. In some examples, the model 400 incorporates a dual-head structure during training. A first head 422 focuses on reconstructing a clean frame from degraded input (e.g., removing/correcting for artifacts). A second head 430 focuses on predicting the QP level of the input frame. This QP prediction head helps the model understand the severity of degradation, guiding it to adjust its reconstruction strategy accordingly. It was observed that this type of multi-head approach to training helped the model navigate the quality of the images. Note that during inference time, the second head 430 may be deleted/dropped/not used. An alternative approach for leveraging the second head is provided below in connection with the description of FIG. 4B.

At 402, a given input image 401 is subjected to a pixel unshuffle operation in order to reduce the spatial dimensions of the image and increase the channel depth. Note that depending on the goals of training, the input image 401 may be in RGB color space, YUV color space, or another color space as needed. In some examples, just the Y of the YUV color space is used during training.

In any event, a pixel unshuffle operation is performed on the input image 401. Different r values for the pixel unshuffle operation may be used in certain examples. In certain examples, an r value of 2 may be selected. With such a selection, the spatial dimensions of the input image are reduced by a factor of 2 (in each direction) while increasing the channel depth by the factor of 4—e.g., HxWXC→H/2×W/2×4C. This effectively reduces the resolution of the image by ¼. Other r values may be used depending on the particular model that is being trained. In certain examples, the r value may be selected depending on the upscaling factor that is desired. As an illustrative example, if a 540p image (1×540×960) is provided as input, then the resulting tensor may be 4×270×480. This reduces the spatial dimensions of the input that is processed by the model.

The training then proceeds through the encoder path 410 of the UNet model 400 where the features of the tensor are extracted and the spatial dimensions further decreased. In certain example embodiments, the number of convolutions in the encoder path may be less than 5. In the example shown in FIG. 4A, 4 convolution layers are used for the encoder path. It will be appreciated that as more layers are added, the slower the network will be during inference and/or may require additional processing power.

From the features extracted from the encoder path 410, second head 430 generates a QP prediction value 432 for the input image 401.

The UNet model 400 also includes a portion of the model that is called the bottleneck 411 (or the “middle” of the model) or the lowest level of the model. Note that in some examples, the second head 430 generates a QP prediction value 432 after the convolutions are performed in the bottleneck 411. In some examples, 1, 2, or 3 convolutions may be performed in this portion of the model.

The model then continues onto the decoder path 412. The decoder path may handle up sampling the lower spatial resolution and decreasing the channel density. In some examples, features from the encoder path are used as well (e.g., via skip connections).

As discussed above, different instances of model 400 may be trained to handle different output resolutions. This allows, for example, different resolutions (e.g., ×1, ×1.33, ×1.5, ×2, or ×3) to be supported within multiple instances of a lightweight model. This also allows the upscaling capability to be integrated directly into the network architecture by adjusting the number of filters before a final pixel shuffle operation 420. This allows the network to maintain a smaller spatial dimension throughout most of the processing and perform efficient upscaling in the final reconstruction layer of the network. In certain example embodiments, the number of convolution layers for handling ×2 upscaling may be less than 10 (e.g., 8 or 9).

After the final layer of the decoder path is performed, then a pixel shuffle operation may be performed to flatten the channel data into spatial dimensions. As an illustrative example, if the final tensor is 16×270×480, then the pixel shuffle (r=2) operation will generate a 1080p image.

After pixel shuffling (increasing the spatial size and reducing channel depth), the first head 422 outputs a resulting image 424.

At 440, the loss is calculated. Specifically, the L1 loss is computed for the output image 424 to the ground truth image 442 and the L2 loss is computed for the QP prediction 432 and the QP of the original input image 444. In certain example embodiments, the loss may be a function of any or all of the following elements: 1) an L1 loss on the resulting image in relation to the ground truth; 2) a calculation of a Structural Similarity Index Measure (SSIM) based on the resulting image and/or the ground truth; and/or 3) an L2 loss on the QP prediction.

The L1 loss is used to help train towards pixel pixel-level accuracy. The SSIM help to train towards the perceptual quality of the restored frames. The L2 loss of the QP prediction head help to train towards accurate assessment of degradation severity.

In certain example embodiments, the total loss that is calculated at 440 is TotalLoss=3×L1+2×SSIM+0.5×L2 (QP prediction).

Training may continue until the model appropriately converges.

FIG. 4B is an alternative architecture that leverages the predicted QP value (432) into selecting one of multiple possible decoder paths 413 (413A, 413B, 413C) that each correspond to different QP values or range of QP values (xQP1, xQP2, xQPn). The architecture shown in FIG. 4B may be used in connection with the adaptive artifact removal techniques discussed herein. Note that the bottleneck element is not shown in FIG. 4B to show the various decoder paths more clearly.

### Description Of FIG. 5: Training System

FIG. 5 is a block diagram that includes an example training computer system according to certain example embodiments. Training computer system 500 is an example of computer system 1100 that is shown in FIG. 11. In certain example embodiments, computer system 500 and computer system 100 may be the same system (e.g., the system that is used to play a video game also may be configured to train a neural network for that video game). In certain examples, the training computer system 500 may be a distributed computing system.

Training computer system 500 includes storage for training datasets 502 and a dataset preparation module 504. The training datasets may be, as discussed in connection with FIG. 3, a combination of input and ground truth images and structured images or game engine rendered images. Other image types may be used in certain examples.

Dataset preparation module 504 may execute the processing shown in FIG. 3 in order to (for example) prepare images for use by training module 508 (which may execute the network architecture shown in FIG. 4A or 4B). Models that are trained may then be stored to trained model storage 510.

Trained model(s) 512 may then be distributed to game device 100, 101, computing device 150, etc. for use thereon.

Note that because the models being trained are relatively small (e.g., less than 1 million, or 500k parameters), they process data relatively quickly and thus may burn through training data before it can be prepared. Accordingly, as part of the training process, and in order to improve training stability and efficiency in certain examples, the training computer system 500 may use a curriculum learning approach using a dynamically managed circular buffer 506 containing thousands (e.g., between 10 k and 50 k, such as around 30 k) of images (e.g., cropped samples) that are continuously updated for training.

When training of a new model begins, the circular buffer 506 is initially populated with a limited amount of structured training data (e.g., structured images 304). At this early stage, the buffer size is relatively small, allowing the training module 508 to frequently iterate (e.g., loop over the content of the circular buffer) through this structured data, enabling rapid initial learning of fundamental visual features. As training progresses, the circular buffer gradually expands until it reaches a predefined or threshold maximum size limit (which may be set at the start of training). This threshold is provided to ensure sufficient data diversity and entropy, thereby reducing the frequency with which the training module revisits previously used images. Once the buffer is full, the data provider continues to introduce new training samples by replacing the oldest entries. Concurrently, the buffer begins incorporating (via being provided by dataset preparation module 504) more complex training samples derived from actual game images 302. In certain implementations, as training advances further, the initially loaded structured images may be progressively replaced or removed entirely, ensuring the model continuously encounters diverse, challenging, and contextually relevant scenarios.

This approach was found to help with training as the buffer's relatively low initial entropy helps the model more rapidly converge by repeatedly presenting similar simpler examples. The buffer can then be updated/filled to introduce gradually increasing complexity and variability of the training data.

### Description Of FIG. 6: Inference Processing

FIG. 6 is a flow chart of processing performed at run time for processing compressed media according to certain example embodiments. The processing shown in FIG. 6 may be performed on a compressed video or image stream that is provided via a network or stream locally in certain examples.

Compressed media 138 is received by a computing system and loaded into memory. At 600, the RGB values of the image data are converted into YUV space.

From here inference is performed with the Y value against the trained model 510 to generate processed Y* value 604B. In some examples this Y may be an upscaled version (e.g., twice the resolution) of the compressed image. In other examples, it may be the same resolution.

At 610, the processed Y* is used to upscale UV values 602B. In certain examples, the UV chrominance channels are upscaled using bilinear conversion (e.g., interpolation) based on (e.g., guided by) the processed Y* channels higher quality output from the model 510. It was found that this type of approach helped to maximize the perceived sharpness and visual quality of the final image. In other words, this approach helps to define the edges between colors within the image.

In certain example embodiments the following process for determining the upscaled UV values for each pixel may be performed. A group of pixels (e.g., a 5×5 square) of the YUV input resolution (from 600). For example, +/−2 pixels in the height of and width. In other examples the group may be +/−1 or 3 pixels (or more). In some examples, the height and width may be different for the selected group (e.g., a 3×5 rectangle). From the selected input group of pixels, a weighted linear regression between input Y and input UV is performed by interpolating using the correct Y* (604B).

In certain examples, the following processing performed at 610 may also include having both inputs and outputs for YUV values be unsigned. The UV is 2 times smaller than Y (e.g., YUV420) in input and output. The same upscaling ratio may be used for the algorithm and the network (at 510). It will be appreciated that computing each output pixel may require (e.g., in the case of a 5×5 group) 25 YUV values for the operation.

In certain example embodiments, the processing performed may operate at least at 60 FPS, or at least 30 FPS.

Note that in certain instances, if there is no upscaling required (e.g., if the scaling factor is ×1), then the UV bilinear conversion may be skipped.

At 612, processed YUV* image data is generated based on the processed UV* and Y* channels. At 614, the YUV* image data is then converted to RGB.

The resulting image may then be output (e.g., to a display) and/or subjected to further processing at 616.

In certain example embodiments, the compressed media 138 may be received from one or more other computing systems and then integrated into a display that is presented on a local computing device to a user. For example, the compressed media 138 may be received via a network connection that is between a local computing device and one or more remote computing devices. The remote computing devices may be on a local network (e.g., a local wireless network) or may be communicating via, for example, the Internet. In some examples, the compressed media may be game images (e.g., a stream of game image data) and/or image data from, for example, a camera or the like. Accordingly, the compressed media may vary in type and/or kind according to various examples.

In some instances, multiple different instances of compressed media may be received by the same computing device. For example, 4 players (each using their own instance of game device 100) may be playing a video game and 3 of those players may be streaming gameplay of the video game to the fourth player. Each of these streaming instances may be an instance of compressed media 138 that is processed using the techniques discussed herein.

As a further illustrative example, a graphical user interface may concurrently display the image data received from 3 different game devices-along with the image data generated from a local instance of the video game (e.g., from game engine 112). In some examples, the 3 different instances of compressed media are combined into a single frame buffer and then subjected to the processing shown in FIG. 6. In other examples, each instance of compressed media is separately subjected to the processing shown in FIG. 6 before being combined into a single display that includes video streams from the 3 separate computing devices.

### Description Of FIGS. 7AA-10B: Banding Removal

Banding artifacts include visible and/or unwanted discontinuities or “bands” in what should ideally be smooth color and/or brightness transitions within an image or video. They typically appear as distinct, abrupt steps between slightly different shades, rather than displaying continuous and smooth gradients. Banding often arises due to limited color depth or quantization effects, especially in digital images and videos stored in compressed formats or represented with insufficient bit-depth (e.g., 8-bit per color channel). These artifacts are most noticeable in scenes containing subtle gradients, such as skies, fog, dark areas, or smoothly shaded surfaces, and become even more visually distracting during motion or when the content is upscaled to higher resolutions.

In certain example embodiments, video game assets (e.g., movies, images, etc.) can exhibit banding artifacts caused by compression. The results of such compression artifacts are shown in FIGS. 7A, 8A, 9A, and 10A. Accordingly, in certain example embodiments a ML model may be trained and then selectively used to remove banding that may be in video game assets. This approach can also be more space efficient as uncompressed videos can be extremely large in size.

FIG. 7AA is a flow chart of a runtime process that may be performed during execution of a video game according to certain example embodiments.

At 700 game process is performed. This may include processing input provided by a user, updating object information, and other game process that may be performed during a video game. At 702, the game may render an image of a virtual game space. The resulting frame may be stored in a buffer (e.g., memory). Subsequently, a model is used to upscale images to higher resolution may be executed at 706 to generate an upscaled image that is then output at 720. Additional description for how images may be upscaled may be found in U.S. Pat. No. 11,494,875, the entire contents of which are hereby incorporated by reference.

In some examples, the resulting rendered image data may be represented as uint8 values (e.g., 3 bytes per pixel if using RGB). However, as part of the upscaling processing that may be performed in certain examples, the image data may be converted to, for example, float16 or float32 for additional precision. In other examples, the resulting render target may be float16 or float32 (e.g., in the case of HDR image data). In certain example embodiments, the image data that is processed via the upscaling model at 706 may take a float16 (or float32) and output a similar float16 (or float32).

Some video games may have prerendered or prepared movies to provide a more cinematic experience. These may be stored as movie files or other video game assets that may be loaded when needed. An issue with such movie files is that they may include banding artifacts. And such artifacts may become especially noticeable in dark, smoothly shaded scenes featuring significant camera or object motion-particularly when the video content is upscaled to higher resolutions. The techniques herein seek to address such banding.

Accordingly, the video game processing at 700 may determine when video game assets are to be used. In certain example embodiments, processing may be added to game device 100 in order to detect, at 712, when a video game asset (such as a movie of the like) is to be accessed as part of the video game. This may include modifying the system services of a game device and/or modifying the code of the game application 110. When the game asset is to be accessed, it is loaded at 714.

With the loading of the game asset, a ML model that has been trained (as discussed in greater detail herein) to remove banding may be executed at 716. The output image from the ML model may then be written, as output image data, at 704, which may then be upscaled via an upscaling model at 706 (e.g., in the same or similar manner to image data output from render 702).

In some examples, the video game assets that are loaded at 714 may have been stored at, for example, uint8 or the like (e.g., a first precision). In such instances, processing that is performed when loading an asset may be to convert the image data to a higher precision (e.g., a second precision), such as float32, float16, or the like, and then use the higher precision values as input for the band removal model at 716. Increasing the precision of the image data allows for the model (which may have been trained on float32 or float16 data as discussed herein) to provide a higher precision output from 716.

The resulting higher precision output may then be used as input for the upscaling model at 706 to produce upscaled image data. In some examples, the resulting image may be converted back to uint8. A downside of this is that banding artifacts may end up returning due to the quantization back to the lower precision values (e.g., uint8).

To assist in counteracting the reintroduction of the banding to the now upscaled image data, a dithering process may be applied to the image data at 708 (the output from the upscaling model). The resulting image data from that dithering process may then be converted back to uint8 before being stored/output (e.g., displayed) at 720. In certain examples, the dithering may apply blue noise to the image data. An illustrative example of blue noise dither process is shown in Table 2 below. The dithering and application of the blue noise as a post-processing element may decrease, or eliminate, any residual banding.

In some examples, the dithering process can be used to prevent or counteract display devices (e.g., LCD/OLED displays, etc.) from reintroducing banding effects that sometimes can occur when there is little or no noise in source image data. By injecting noise into the image data, it can provide a “better” quality image output in some examples.

In certain examples, dithering is applied to an image while it is represented in a high-precision format. For example, if the image is encoded in standard dynamic range (SDR), the dithered result is subsequently converted to a lower-precision format, such as 8-bit per channel, for downstream processing such as rendering, storage, etc. Conversely, if the image is in high dynamic range (HDR) or the like, the dithered image may remain in high precision format (e.g., higher than 8-bits per channel) and be used directly in downstream processing, rendering, etc.

The processing discussed herein may be performed on each frame of a video or on each image frame that is displayed as part of a video game or otherwise.

The following is an illustrative example of pseudocode for removing banding effects from a frame of a video (e.g., an image).

TABLE 1
Debanding Function

```
FUNCTION process_video_frame(compressed_frame_rgb_uint8, blue_noise_0,
blue_noise_1):
// Step 1 - Convert to float16
  frame_float16 ← convert_to_float16(compressed_frame_rgb_uint8)
// Step 2 - Apply deep neural network for gradient restoration (e.g., 716)
  restored_frame_float16 ← gradient_restoration_model(frame_float16)
// Step 3 - Upscale the restored image (e.g., 706)
  upscaled_frame_float16 ← super_resolution_model(restored_frame_float16)
// Step 4 - Apply blue noise dithering (e.g., 708)
  dithered_frame_float16 ← apply_blue_noise_dithering(upscaled_frame_float16,
blue_noise_0, blue_noise_1)
// Step 5 - Convert to uint8 for rendering or storage (e.g., 710)
  output_frame_uint8 ← convert_to_uint8(dithered_frame_float16)
RETURN output_frame_uint8
```

The “process_video_frame” function from Table 1 may be used in combination with an “apply_blue_noise_dithering” function that is shown in Table 2 below.

TABLE 2
Dither Function

```
FUNCTION apply_blue_noise_dithering(image, blue_noise_0, blue_noise_1):
// image: input image as float16, shape (H, W, C), values in [0, 255]
// blue_noise_0: float16 noise map, shape (H, W, C), values in [0, 1]
// blue_noise_1: float16 noise map, shape (H, W, C), values in [0, 1]
// Step 1 - Combine the two blue noise maps and center around zero
combined_noise ← blue_noise_0 + blue_noise_1 − 0.5
// Step 2 - Add noise and clamp
FOR each pixel (x, y, c) in image:
  value ← image[x, y, c] + combined_noise[x, y, c]
  value ← floor(value)
  image[x, y, c] ← clamp(value, 0, 255)
RETURN image
```

The image that is returned from apply_blue_noise_dithering function may be the output of 708. And the output frame that is returned from the process_video_frame may be the output at 720.

The process shown in FIG. 7AA may be modified in certain examples. For example, the output from the renderer 702 may be used as input for the band removal model at 716. In other examples, the output from the renderer 702 may be sufficiently high resolution that it does not need to be further upscaled at 706. Accordingly, different possible pipelines may be implemented using the techniques described herein.

FIGS. 7A and 7B are screen shots, in color, that illustrate before and after images; FIGS. 8A and 8B show zoom in portions, in color, of a portion of the images from FIGS. 7A and 7B; FIGS. 9A and 9B are grayscale versions of FIGS. 8A and 8B; FIGS. 10A and 10B are grided versions, in color, of FIGS. 8A and 8B to illustrate the before and after of the banding processing that may be performed according to certain example embodiments. These images illustrate various aspects of banding that may occur within images and how an ML model can be used to assist in removing such artifacts-before the images are then upscaled.

Note that the video assets being processed in this manner may be considered relatively clean of compression artifacts—but may still exhibit some artifacts and significant banding issues. To address this another ML model is trained (e.g., 716) to specifically address banding by generating smooth gradients in affected areas.

Training a debanding ML model (such as used at 716) includes preparing an appropriate training dataset. The training dataset may include input frames from the video game assets of 1080p resolution and ground truth frames available as 4K images. However, such images may still themselves exhibit banding (e.g., due to quantization to uint8). To address this, the ground truth images are pre-processed to generate smooth gradients wherever RGB values differ by a single unit or more, effectively removing banding. This processed ground truth is stored in float32 (as opposed to uint8 for example) format (e.g., in exr files) to preserve a smooth gradient accuracy. The model may then be trained. More specifically, the model may be trained to create a continuous set of values where a gradient is expected or needed. In certain examples, the model architecture shown in FIG. 4A or 4B is used. In some examples, a previously trained model (from FIG. 2) is used as a basis for further fine-tuning.

As an illustrative example, an example UNet model may include 5 convolutions at the encoder layer, 2 convolutions at the middle layer, and 5 convolutions at the decoder layer (12 total convolutional filters). This 3 level UNet model may have between 100 k and 200 k parameters. It will be appreciated that the processing demands (e.g., as the image may still be upscaled) may require a relatively extremely fast model in which inference is performed.

This approach allows a specific debanding ML model to be dynamically activated when, for example, a cinematic scene or movie file/data is being processed as part of game processing 700.

For this training scenario (unlike what is shown in FIG. 2), the model processes RGB data (e.g., all 3 channels) directly (instead of using YUV) and is trained on the L1 loss. This was found to help prevent chromatic artifacts and maintain color fidelity. In certain example embodiments, a dithering step (e.g., 708) is used based on blue noise and applied as a post-processing operation (e.g., after upscaling). This step may help ensure that the smooth gradients are recovered by the model, which may have been originally lost due to compression or quantization. Moreover, this was found to assist in preventing reintroduction of banding artifacts when the resulting images are subsequently quantized back to standard formats (e.g., uint8).

In some circumstances, this type of approach allows leveraging already produced video game assets without having to reproduce the video game assets (e.g., redo the movie with a larger textures, etc.) if a higher resolution is desired.

### Description Of Adaptive Artifact Removal—Trained

In certain example embodiments, the training of a model may use explicit knowledge of a video stream quality (e.g., the quality of the image frames therein) as part of the inference processing. In certain example embodiments, the quality of an image frame may be determined based on the Quantization Parameter (QP) that is used during H264 encoding. A trained model may leverage this value to enable a more adaptive and/or fine-grained artifact removal during inference. FIG. 4B provides an illustrative example of such an architecture.

In certain example embodiments, the UNet-based neural network architecture may leverage the explicit knowledge of a QP value (or other similar value regarding the quality of an image frame—such as a prediction) and dynamically adapt its reconstruction behavior.

In certain examples, the UNet model (e.g., the a first portion of the (encoder and early decoder stages) generates an embedding, which is a high-level internal representation of the input frame. This captures relevant details about the scene complexity and degradation level. The embedding may be based on the results of the encoder path of the UNet and/or early parts of the decoder path.

From this embedding, an auxiliary “QP prediction head” can estimate the QP value associated with the provided input frame. This prediction provides a direct indicator of how aggressively the current frame should be cleaned.

Based on the predicted QP value, the model then dynamically selects and applies a specialized set of weights in the subsequent steps in the decoding path. This effectively transforms the second portion of the UNet architecture into a “mixture of experts,” each “expert” set of weights being specifically optimized to handle a certain compression quality level. Accordingly, one or more decoding blocks of the decoding path of the UNet model may be adjusted based on the predicted QP of the input image. In other words, as an example, output 432 may be used to adjust one or more of decoder blocks of (in 413A, 413B, 413N, etc.—with each including multiple decoder blocks as needed for upscaling) during training and/or inference.

During training each weight set (e.g., each “expert”) is determined for a given set of QP value(s). Each weight set may be associated with a single QP value or a range of QP values. This approach can thus allow the model to dynamically adapt to varying compression levels and scene complexities (as represented by the QP values or the like)—thus improving overall output quality compared to a static, single-weight-set network.

It will be appreciated that this type of dynamic weighting approach is particularly beneficial in some scenarios—especially those that involve games, and game applications that tend to exhibit a large range of artifact severities (e.g., due to varying network conditions, scene complexity, etc.) that can be encountered in real-time compressed gaming streams (e.g., that may be provided via H264 or the like).

### Description Of Adaptive Artifact Removal—External

In certain example embodiments the QP value may be an externally obtained QP value from the video decoding pipeline. For example, rather than predicting the QP within the model itself, the system may directly use the actual QP from the decoder at runtime to then choose the best-matching complete model trained specifically for that QP value.

In this type of setup, multiple UNet models can be maintained in parallel (e.g., with each being compact and lightweight)—with each being trained a specific QP value (or a range of QP values). During inference, the decoder-supplied QP value is used to select the appropriate trained model. This type of approach may be advantageous in certain examples (e.g., over the mixture-of-experts scenario described above in connection with FIG. 4B). For example, it advantageously operates with decreased overhead at inference time-thus making it particularly suitable for real-time operations on processing constrained computing devices (e.g., such as mobile game devices).

### Description Of FIG. 11

FIG. 11 is a block diagram of an example computing device 1100 (which may also be referred to, for example, as a “computing device,” “computer system,” or “computing system”) according to some embodiments. In some embodiments, the computing device 1100 includes one or more of the following: one or more processors 1102 (which may be referred to as “hardware processors” or individually as a “hardware processor”); one or more memory devices 1104; one or more network interface devices 1106; one or more display interfaces 1108; and one or more user input adapters 1110. Additionally, in some embodiments, the computing device 1100 is connected to or includes a display device 1112. As will explained below, these elements (e.g., the processors 1102, memory devices 1104, network interface devices 1106, display interfaces 1108, user input adapters 1110, display device 1112) are hardware devices (for example, electronic circuits or combinations of circuits) that are configured to perform various different functions for the computing device 1100. In some embodiments, these components of the computing device 1100 may be collectively referred to as computing resources (e.g., resources that are used to carry out execution of instructions and include the processors (one or more processors 1102), storage (one or more memory devices 1104), and I/O (network interface devices 1106, one or more display interfaces 1108, and one or more user input adapters 1110). In some instances, the term processing resources may be used interchangeably with the term computing resources. In some embodiments, multiple instances of computing device 1100 may be arranged into a distributed computing system.

In some embodiments, each or any of the processors 1102 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1102 uses an instruction set architecture such as x86 or Advanced RISC Machine (ARM). In some embodiments, each or any of the processors 1102 is or includes, for example, a graphical processing unit (GPU), which may be an electronic circuit designed to generate images and the like. One or more of the processors 1102 may be referred to as a processing system in certain examples.

In some embodiments, each or any of the memory devices 1104 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1102). Memory devices 1104 are an example of non-transitory computer-readable storage.

In some embodiments, each or any of the network interface devices 1106 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices 1106 may include ports or other connections that enable such connections to be made and communicate data electronically among the various components of a distributed computing system.

In some embodiments, each or any of the display interfaces 1108 is or includes one or more circuits that receive data from the processors 1102, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1112, which displays the image data. Alternatively, or additionally, in some embodiments, each or any of the display interfaces 1108 is or includes, for example, a video card, video adapter, or graphics processing unit (GPU). In other words, the each or any of the display interfaces 1108 may include a processor therein that is used to generate image data. The generation or such images may occur in conjunction with processing performed by one or more of the processors 1102.

In some embodiments, each or any of the user input adapters 1110 is or includes one or more circuits that receive and process user input data from one or more user input devices (1114) that are included in, attached to, or otherwise in communication with the computing device 1100, and that output data based on the received input data to the processors 1102. Alternatively, or additionally, in some embodiments each or any of the user input adapters 1110 is or includes, for example, a PS/2 interface, a USB interface, a touchscreen controller, or the like; and/or the user input adapters 1110 facilitates input from user input devices 1114.

In some embodiments, the display device 1112 may be a Liquid Crystal Display (LCD) display, Light Emitting Diode (LED) display, or other type of display device. In embodiments where the display device 1112 is a component of the computing device 1100 (e.g., the computing device and the display device are included in a unified housing), the display device 1112 may be a touchscreen display or non-touchscreen display. In embodiments where the display device 1112 is connected to the computing device 1100 (e.g., is external to the computing device 1100 and communicates with the computing device 1100 via a wire and/or via wireless communication technology), the display device 1112 is, for example, an external monitor, projector, television, display screen, etc.

In some embodiments, each or any of the input devices 1114 is or includes machinery and/or electronics that generates a signal that is provided to the user input adapter(s) 1110 in response to physical phenomenon. Examples of input devices 1114 include, for example, a keyboard, a mouse, a trackpad, a touchscreen, a button, a joystick, a sensor (e.g., an acceleration sensor, a gyro sensor, a temperature sensor, and the like). In some examples, one or more input devices 1114 generate signals that are provided in response to a user providing an input—for example, by pressing a button or actuating a joystick. In other examples, one or more input devices generate signals based on sensed physical quantities (e.g., such as force, temperature, etc.). In some embodiments, each or any of the input devices 1114 is a component of the computing device (for example, a button is provide on a housing that includes the processors 1102, memory devices 1104, network interface devices 1106, display interfaces 1108, user input adapters 1110, and the like).

In some embodiments, each or any of the external device(s) 1116 includes further computing devices (e.g., other instances of computing device 1100) that communicate with computing device 1100. Examples may include a server computer, a client computer system, a mobile computing device, a cloud-based computer system, a computing node, an Internet of Things (IoT) device, etc. that all may communicate with computing device 1100. In general, external devices(s) 1116 may include devices that communicate (e.g., electronically) with computing device 1100. As an example, computing device 1100 may be a game device that communicates over the Internet with a server computer system that is an example of external device 1116. Conversely, computing device 1100 may be a server computer system that communicates with a game device that is an example external device 1116.

In various embodiments, the computing device 1100 includes one, or two, or three, four, or more of each or any of the above-mentioned elements (e.g., the processors 1102, memory devices 1104, network interface devices 1106, display interfaces 1108, and user input adapters 1110). Alternatively, or additionally, in some embodiments, the computing device 1100 includes one or more of: a processing system that includes the processors 1102; a memory or storage system that includes the memory devices 1104; and a network interface system that includes the network interface devices 1106. Alternatively, or additionally, in some embodiments, the computing device 1100 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 1102 and the network interface devices 1106; or the single SoC (or the multiple SoCs) may include the processors 1102, the network interface devices 1106, and the memory devices 1104; etc.

The computing device 1100 may be arranged in some embodiments such that: the processors 1102 include a multi or single-core processor; the network interface devices 1106 include a first network interface device (which implements, for example, WiFi, Bluetooth, NFC, etc.) and a second network interface device that implements one or more cellular communication technologies (e.g., 3G, 4G LTE, CDMA, etc.); the memory devices 1104 include RAM, flash memory, or a hard disk. As another example, the computing device 1100 may be arranged such that: the processors 1102 include two, three, four, five, or more multi-core processors; the network interface devices 1106 include a first network interface device that implements Ethernet and a second network interface device that implements WiFi and/or Bluetooth; and the memory devices 1104 include a RAM and a flash memory or hard disk.

The hardware configurations shown in FIG. 11 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 11, (e) via other hardware arrangements, architectures, and configurations, and/or via combinations of the technology described in (a) through (e).

### Technical Advantages of Described Subject Matter

In certain example embodiments, machine learning models are used to assist in removal of compression artifacts from video streams or images. Models may also be used to remove banding that may be present in already existing video game assets.

### Selected Terminology

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

### Additional Applications of Described Subject Matter

Although process steps, algorithms or the like, including without limitation with reference to FIGS. 2-7AA, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A method of training a machine learning model for processing compression artifacts included in video game images, the method comprising:
retrieving input images that are each associated with a corresponding ground truth image;
generating modified input images by applying, for each of the input images, a blurring process to the input image that is based on the corresponding ground truth image for that input image;
generating training data based on compressing, using a compression process, the modified input images, the training data comprising training images that each are associated with a corresponding ground truth image, wherein multiple different ones of the training images are associated with the same corresponding ground truth image and compressed with varying compression quality;
executing a training process to train a machine learning model based on the generated training data and a loss function, wherein the training processing includes:
a) encoding feature data based on the training data,
b) generating first and second prediction heads based at least in part on the encoded feature data, and
c) calculating a loss for the training process that uses outputs from the first and second prediction heads in the loss function; and
based on convergence of the machine learning model, storing one or more trained machine learning models.

2. The method of claim 1, wherein the second prediction head is removed from the one or more trained machine learning models that are stored.

3. The method of claim 1, wherein the second prediction head predicts a quality parameter used in the compression process.

4. The method of claim 1, wherein the blurring process is a Gaussian blur.

5. The method of claim 3, further comprising: calculating, for each corresponding ground truth image, a Sobel mask, wherein the blurring process is further based on the calculated Sobel mask of the corresponding ground truth image.

6. The method of claim 1, wherein the loss function is based on an L1 loss from an output image of the training and a corresponding ground truth image, an L2 loss based on a quality parameter used in compression of the training image and a predicted quality parameter, and a Structural Similarity Index Measure (SSIM) based on the output image and/or the corresponding ground truth image.

7. The method of claim 1, wherein the input images includes a plurality of first image types and a plurality of second image types, wherein the first image type includes video game images generated from video game engines, wherein the second image type includes geometric images.

8. The method of claim 7, further comprising:
as part of the training process for a given machine learning model, initially starting the training process with images of the second image type and then replacing images of the second image type with those of the first image type.

9. The method of claim 8, further comprising:
expanding, over the training process, a circular buffer into which the training data is populated for the training of the machine learning model.

10. The method of claim 1, wherein the compression process includes applying a video compression algorithm that includes a quality parameter, wherein different values for the quality parameter vary the compression quality, wherein the second prediction head is based on the quality parameter.

11. The method of claim 1, wherein the machine learning model is a UNet model.

12. The method of claim 1, further comprising:
training a plurality of different variations of a trained machine learning model that each include different upscaling factors.

13. The method of claim 1, wherein the training images are at a first resolution and the corresponding ground truth image for each training image is at a second resolution that is greater than the first resolution.

14. A method of decreasing compression artifacts included in video displayed on a computing system, the method comprising:
obtaining compressed image data of a compressed video stream;
obtaining, based on YUV color space of the compressed image data, source luma data and source chroma data;
performing machine learning inference with the source luma data against a trained machine learning model to generate output luma data;
generating output chroma data by interpolating the source chroma data using the output luma data;
generating output image data based on the output luma data and the output chroma data; and
rendering, to a display, an output video stream based on the generated output image data.

15. The method of claim 14, further comprising:
receiving, from another computing device, the compressed image data; and
converting the compressed image data from RBG color space to YUV color space,
wherein generating the output image data includes converting the output luma data and the output chroma data to RGB color space.

16. The method of claim 14, wherein the compressed image data is at a first resolution and the output image data is a second resolution that is greater than the first resolution.

17. The method of claim 14, wherein the output chroma data is generated by performing bilinear conversion of the source chroma data using the output luma data.

18. The method of claim 14, further comprising:
executing a video game; and
displaying images of the video game and concurrently outputting the video stream at a rate of at least 30 frames per second.

19. A method of reducing or removing banding artifacts included in videos of a video game displayed on a computing system, the method comprising:
executing a video game application;
generating, based on a virtual space for the video game, video game image data;
during execution of the video game application, determining access to at least a first video asset of the video game that is stored at an original resolution;
based on determination of access to at least the first video asset of the video game, performing machine learning inference with image data of the first video asset against a first trained machine learning model to generate band-corrected image data;
performing machine learning inference with the band-corrected image data against the second trained machine learning model to generate upscaled image data of the first video asset
applying blue noise dithering to image frames of the upscaled version of the first video asset to generate dithered image data; and
outputting, based on the dithered image data, an upscaled version of the first video asset that has reduced banding artifacts.

20. The method of claim 19, further comprising:
converting the dithered image data from a first precision to a second precision that is less than the first precision, wherein image frames are output based on the first precision.

21. The method of claim 19, wherein the upscaled version of the first video asset is output in HDR (high dynamic range).
